(19) United States
(12) Patent Application Publication
(10) Pub. No.: US 2019/0039864 A1
(43) Pub. Date: Feb. 7, 2019

(54) SUPPORTING STRUCTURE FOR A CRANE, AND CRANE THEREWITH

(71) Applicant: Konecranes Global Corporation, Hyvinkää (FI)

(72) Inventors: Jörg Stötzel-Lucas, Leichlingen (DE); Sunanth Venkateshwaran, Düsseldorf (DE)

(21) Appl. No.: 16/072,103

(22) PCT Filed: Jan. 11, 2017
(86) PCT No.: PCT/EP2017/050498

§ 371 Date: Jul. 23, 2018

(30) Foreign Application Priority Data
Jan. 25, 2016 (DE) 10 2016 101 212.2

(51) Int. Cl. B66C 23/70

(52) U.S. Cl. CPC B66C 23/70; B66C 23/36

(57) ABSTRACT

The invention relates to a supporting structure for a crane, in particular for a framework construction of a mast or crane girder, in particular a jib, or for a bracing construction of the crane, wherein the supporting structure comprises a first supporting element and a second supporting element connected to the first supporting element, wherein the second supporting element is produced from a fibre composite material, in particular CFP or GFP. In order to provide an improved supporting structure for a crane, it is proposed that the first supporting element is connected to the second supporting element via a connecting element which has projections which, for fastening to the second supporting element, project into the fibre composite material of the second supporting element, with the result that the connecting element is connected to the second supporting element in a form-fitting manner. The invention also relates to a crane having a correspondingly improved supporting structure.

### CROSS REFERENCE TO RELATED APPLICATION

The present application claims the priority benefits of International Patent Application No. PCT/EP2017/050498, filed on Jan. 11, 2017, and claims benefit of DE 10 2016 101 212.2, filed on Jan. 25, 2016.

### BACKGROUND OF THE INVENTION

The invention relates to a crane comprising a supporting structure which is a component of a latticework construction of a mast or crane girder, in particular of a jib, or of a bracing construction of the crane, wherein the supporting structure comprises a first supporting element and a second supporting element connected to the first supporting element, wherein the second supporting element is produced from a fibre (or fiber) composite material, in particular CFRP or GFRP.

Supporting structures of cranes serve to absorb and dissipate load forces, the force flow of which causes a crane to be loaded in particular during operation by means of moving loads. Depending upon the type of crane, such supporting structures can be a component of latticework constructions of masts or crane girders, in particular of jibs. In this case, the cranes referred to include e.g. tower cranes, crawler cranes, lattice mast crawler cranes, industrial cranes, process cranes, wharf cranes, in particular mobile wharf cranes, rail-borne wharf cranes, floating cranes, tyred wharf gantry cranes, container bridges (so-called ship-to-shore cranes) or container stacker cranes. The aforementioned cranes can also have bracing constructions with supporting structures formed by rigid, rod-shaped, in particular tubular, bracing elements in order to secure or additionally stabilise and brace for this purpose crane components, such as e.g. a jib, and therefore stiffen the arrangement of the corresponding crane components.

Since the cranes referred to are used for moving loads of several tonnes, in particular up to several hundred tonnes, the supporting structures and their supporting elements are to be designed to be able to carry heavy loads accordingly. For this reason, in the case of known cranes the supporting structures and their supporting elements are typically produced completely from steel materials.

EP 2 162 634 B1 describes an arrangement for connecting an elongate element to a further component. In this case, a form-fitting connection is produced between a pull element, which is produced from a fibre composite material, for the rigging of sailing vessels or torsional shafts to a further component consisting of metal.

DE 78 27 772 U1 describes that the corner rods of a lattice mast jib can be adhered to reinforcement profiles consisting of CFRP.

DE 202 19 281 U1 describes a bracing element of a crane which has a carbon fibre strip.

In DE 20 2013 003 309 U1 it is mentioned that, as an alternative to steel profiles, chords and rods of a crane girder can be produced from fibre-reinforced materials.

DE 102 58 179 A1 discloses in relation to the lattice girder of a crane jib that its corner bars can consist of a two-shell chord pipe, wherein an inner carbon fibre-reinforced pipe casing is arranged within an outer steel pipe and in this case is connected over the entire surface to the steel pipe.

EP 0 968 955 A2 discloses, in relation to a telescopic jib of mobile cranes, an outer fibre composite reinforcement of the telescopic sections produced from steel.

DE 195 24 901 A1 discloses a force transmission device which is used in vehicle construction for the application of force to running gear unit parts, such as e.g. drive shaft constructions. The force transmission device comprises a fibre composite material.

US 2011/0038666 A1 and EP 1 900 946 A2 disclose force transmission devices for drive shafts which have a fibre composite material.

### SUMMARY OF THE INVENTION

The present invention provides an improved crane comprising a supporting structure. This is achieved by the crane described in claim 1. The dependent claims describe advantageous embodiments of the invention.

In accordance with an aspect of the invention, a crane comprising a supporting structure which is a component of a latticework construction of a mast or crane girder, in particular of a jib, or of a bracing construction of the crane, wherein the supporting structure comprises a first supporting element and a second supporting element connected to the first supporting element, wherein the second supporting element is produced from a fibre composite material, in particular CFRP or GFRP, is improved by virtue of the fact the first supporting element being connected to the second supporting element via a connecting element which has projections which, for fastening to the second supporting element, project into the fibre composite material of the second supporting element so that the connecting element is form-fittingly connected to the second supporting element.

In contrast to known supporting structures, such a supporting structure advantageously has better mechanical properties with a lower empty weight. This thus results in particular in a considerable weight reduction of the crane and improved mechanical properties. In this case, the supporting structure can have a type of outer frame structure which is formed by corresponding first support elements, and can be integrated into the corresponding second supporting elements consisting of fibre composite material and thus in a lightweight design in order to optimise overall the mechanical properties of the entire supporting structure. Therefore, the specific strengths and stiffnesses, which are higher even than high-tensile steel materials, better levels of corrosion resistance and superior fatigue behaviour of corresponding fibre composite materials can be utilised. The form-fitting connection permits in a structurally simple manner a particularly good force flow between the first and second supporting elements. Moreover, the hardening of the plastic component, which is effected during the production of the second supporting element, and the associated fixing of the form-fitting connection mean that, unlike e.g. in the case of an adhesive connection, it is possible to achieve a fast and thus cost-effective connection. Only one hardening step is required. Moreover, by reason of the form-fitting connection and in particular the projections of the connecting element which are provided in this case, it is possible in an advantageous manner to avoid damage to fibres and increase the mechanical loading capacity of the hybrid connection established between the fibre composite material and the material of the first supporting element which differs therefrom.

Advantageous mechanical properties are achieved by virtue of the fact that the second supporting element is rod-shaped, in particular tubular. If a corresponding supporting structure is a component of a bracing construction, the second supporting element can also be designed as a bracing element.

Provision may be made that the connecting element is cylindrical. A correspondingly cylindrical, in particular hollow-cylindrical and thus tubular or sleeve-shaped main body of the connecting element permits a connection between the connecting element and the second supporting element which is simple and has a particularly high loading capacity.

The projections may be arranged on an outer circumferential surface of the connecting element and project, on an inner surface of the second supporting element, in particular at the end thereof, into the fibre composite material and in this case in particular the outer circumferential surface lies against the inner surface.

Provision may be made that the first supporting element is produced from a metallic material, in particular from a steel material. As a result, optimised mechanical properties of the supporting structure can be achieved.

The second supporting element may be fastened to the first supporting element by means of an attachment element, the attachment element is arranged between the connecting element and the first supporting element and is welded to the first supporting element. This permits a particularly stable connection of the first and second supporting elements and a correspondingly good force transmission therebetween.

The second supporting element may be a diagonal strut of a latticework construction of a mast or crane girder, in particular of a jib, or a bracing element of a bracing construction of the crane.

The first supporting element is a component of a top chord or bottom chord of the mast or crane girder, in particular the jib.

### BRIEF DESCRIPTION OF THE DRAWINGS

An exemplified embodiment of the invention is explained in greater detail with reference to the following description. In the figures:

FIG. 1 shows a schematic view of a crane,

FIG. 2 shows a view of a section of the jib of the crane of FIG. 1, and

FIG. 3 shows a schematic sectional view of the connection of a diagonal strut to a bottom chord pipe.

### DETAILED DESCRIPTION OF THE PREFERRED EMBODIMENT

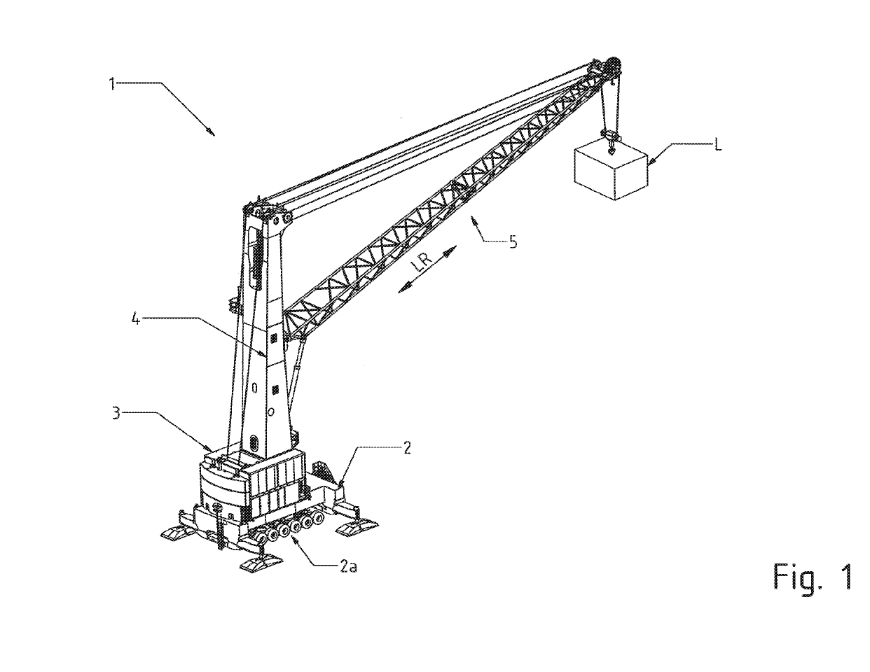

FIG. 1 shows a view of a crane 1 which is designed as a so-called mobile wharf crane for handling standardised containers, in particular ISO containers, between land and water and vice versa and within container terminals. The crane 1 can also be equipped with a gripper for handling bulk materials.

The crane 1 has substantially a lower carriage 2 and a upper carriage 3 with a tower 4 and a jib 5. Typically, the crane 1 is supported on land by means of its lower carriage 2 and its tyred running gear units 2a. The crane 1 is freely movable by means of the tyred running gear units 2a. It is also possible for the crane 1 to be secured so as to be movable on rails or stationary on a floating pontoon. The upper carriage 3 is mounted on the lower carriage 2 in such a manner as to be rotatable about a vertical axis of rotation. The upper carriage 3 also supports a lifting mechanism. Moreover, the tower 4 which extends in the vertical direction and to which the jib 5 is articulated is supported on the upper carriage 3. The jib 5 is connected to the tower 4 so as to be pivotable about a horizontal luffing axis and in addition can be pivoted from its laterally projecting operating position to an upright non-operative position by means of a luffing mechanism which is articulated to the jib 5 and to the upper carriage 3 and is typically designed as a hydraulic cylinder. Rotatably mounted on the tip of the jib 5 remote from the tower 4 are pulleys, by means of which, starting from the lifting mechanism arranged on the upper carriage 3, hoisting cables are guided in the longitudinal direction LR of the jib 5 to the load L to be raised.

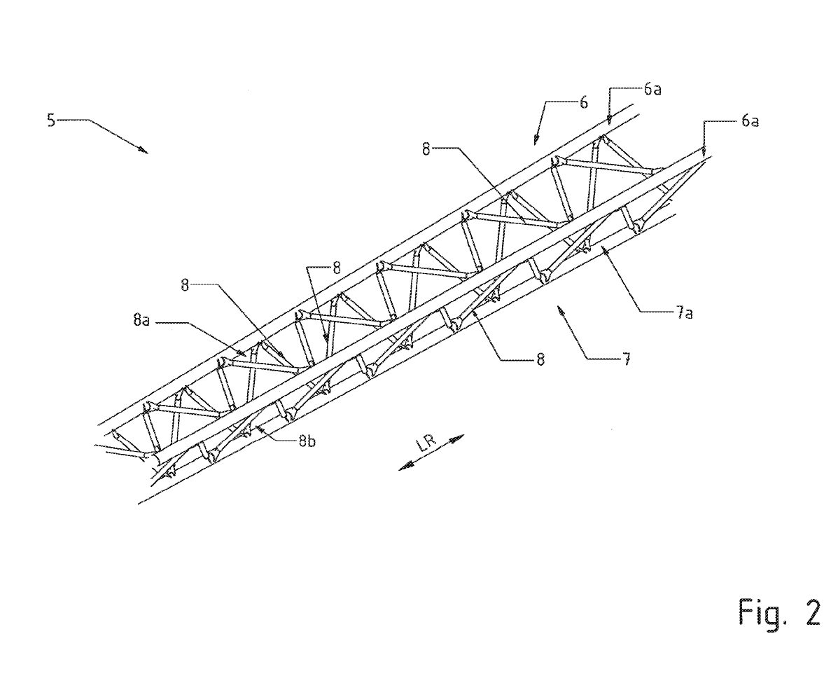

FIG. 2 shows a view of a section of the jib 5 of the crane 1 of FIG. 1. The jib 5 has a latticework-like structure. The latticework construction of the jib 5 comprises in this case a supporting structure having rigid rod-shaped, preferably tubular, elongate supporting elements.

The latticework structure is formed substantially by a top chord 6, a bottom chord 7 and a plurality of diagonal struts 8 which are arranged in the shape of an X as seen transversely to the longitudinal direction LR of the jib 5. The top chord 6 and the bottom chord 7 extend spaced apart from one another in each case in the longitudinal direction LR of the jib 5 and preferably at least partially in parallel with one another. The top chord 6 is formed by two mutually spaced apart top chord pipes 6a which are produced from a metallic material, in particular a steel material. In this case, the elongate, rod-shaped top chord tubes 6a have a round, in particular circular, cross-section. The bottom chord 7 is formed from one bottom chord pipe 7a or is formed, in the same manner as the top chord 6, from two corresponding bottom chord pipes. In the case of only one bottom chord pipe 7a, a triangular cross-sectional structure of the jib 5 is produced as seen in the longitudinal direction LR. In the case of two bottom chord pipes 7a, a quadrangular cross-sectional structure is produced accordingly. The top chord 6 and the bottom chord 7 or the mutually opposing top chord pipes 6a and bottom chord pipes 7a are connected to one another by means of the diagonal struts 8 which extend diagonally therebetween. In particular, in this case each diagonal strut 8 is fastened with a first end 8a to a top chord pipe 6a of the top chord 6 and is fastened with a second end 8b to the associated bottom chord pipe 7a of the bottom chord 7 or is fastened to the opposing top chord pipe 6a. Other arrangements of the diagonal struts 8 and differently designed top chords 6 and bottom chords 7 are also feasible for forming the latticework construction of the jib 5.

In each case, the diagonal struts 8, just like the top chord pipes 6a and bottom chord pipes 7a, are rigid and rod-shaped, in particular tubular and preferably have a round, in particular circular, cross-section. In contrast to the aforementioned components of the latticework construction, the diagonal struts 8 are produced from a fibre composite material, in particular fibre composite plastic (FCP for short) and preferably from CFRP or GFRP. These fibre composite materials are also defined as carbon fibre-reinforced plastic (CFRP for short) and colloquially as carbon or as glass fibre-reinforced plastic (GFRP for short). This relates in each case to a composite material in which carbon fibres or glass fibres are embedded into a plastic matrix. The matrix material serves to connect the fibres and to fill the intermediate spaces. The most varied plastics can be used as the matrix material.

The diagonal struts 8 are produced in a known manner, in that the corresponding carbon fibres or glass fibres are initially arranged, in particular wound or braided, around a mould core, in this case are saturated in an initially liquid or plasticised plastic and are fixed in the matrix formed by the plastic by the subsequent hardening thereof.

Each top chord pipe 6a and each bottom chord pipe 7a serves as a first supporting element of the supporting structure of the latticework construction of the jib 5. Each diagonal strut 8 serves as a second supporting element of the supporting structure connected to the first supporting element. Each first supporting element is produced from a metallic material, in particular steel material, and each second supporting element is produced from a fibre composite material, in particular CFRP or GFRP. The supporting structure thus comprises a hybrid connection between at least one first supporting element and a second supporting element connected thereto and consisting of a material which differs from the material of the first supporting element in the form of the corresponding fibre composite material. The second supporting elements are subjected predominantly to tensile or compression loads.

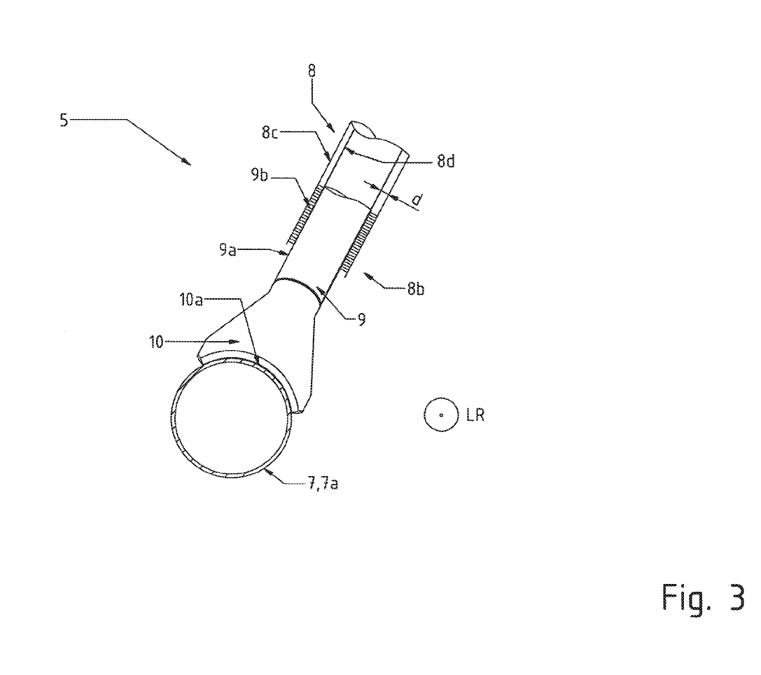

FIG. 3 shows a schematic sectional view of the connection of a diagonal strut 8 to a bottom chord pipe 7a. The figure illustrates a viewing direction in the longitudinal direction LR of the jib 5 and thus of the bottom chord 7 or its bottom chord tube 7a. In order to establish the hybrid connection between the bottom chord pipe 7a serving as the first supporting element and the second end 8b of the diagonal strut 8 serving as the second supporting element, a connecting element 9 is required.

The connecting element 9 is form-fittingly connected to the second supporting element which is formed by the diagonal strut 8, so that the hybrid connection has at least one form-fitting connection. For this purpose, the connecting element 9 has a cylindrical, in particular hollow-cylindrical and thus tubular or sleeve-shaped, main body having a round, preferably circular cross-section. The connecting element 9 is provided, at least in a partial region of an outer circumferential surface 9a of its main body, with pin-shaped projections 9b which are preferably uniformly spaced apart from one another and extend in the radial direction pointing away from the circumferential surface 9a. In this case, as seen in the circumferential direction of the circumferential surface 9a, at least one annular row of mutually spaced apart projections 9b is provided. However, as seen in the direction of the longitudinal extension of the connecting element 9, a plurality of rows of projections 9b preferably extend from the circumferential surface 9a in the radial direction of the connecting element 9. In order to fasten the connecting element 9 to the diagonal strut 8, the projections 9b project at the end 8b of the diagonal strut 8 and within same into the fibre composite material of the diagonal strut 8, but not through the wall 8c of the diagonal strut 8. The outer surface of the diagonal strut 8 is thus free of projections 9b and is thus formed exclusively by fibre composite material, preferably its plastic component. The region of the circumferential surface 9a arranged within the diagonal strut 8 lies preferably against the inner surface 8d of the diagonal strut 8. Accordingly, the wall thickness d of the wall 8c of the diagonal strut 8 has a larger dimension than the length of the projections 9b in the radial direction. As a result, the connecting element 9 is arranged at least partially within the diagonal strut 8 and is surrounded thereby or by the fibre composite material thereof, in particular without the fibres thereof becoming damaged in this case because they are arranged around the projections 9b.

The described form-fitting arrangement is achieved in that, during the production of the second supporting element, i.e. the diagonal strut 8, the connecting element 9 and in particular its projections 9a are surrounded in the region of their intermediate spaces by the fibre composite material and in this case in particular have its fibres wound or braided around them and in addition are surrounded by the matrix material. The form-fitting connection between the second supporting element and the connecting element 9 is fixed by the curing of the plastic component of the fibre composite material of the diagonal strut 8 serving as the matrix material. This renders it possible for force to be applied and transmitted in a reliable and stable manner between the second supporting element and the connecting element 9.

The connecting element 9 is produced in the same manner as the first supporting elements from a metallic material, in particular steel material. As a result, the connecting element 9 can be attached and in particular welded, at its end remote from the diagonal strut 8, in a simple manner to the first supporting element formed by the bottom chord pipe 7a.

For effective application and transmission of force between the connecting element 9 and the first supporting element formed by the bottom chord pipe 7a, an attachment element 10 can be provided between the connecting element 9 and the first supporting element. The attachment element 10 has a recess 10a which is complementary to the surface of the first supporting element in order to lie in a planar manner thereagainst and to be able to be welded thereto. For the illustrated tubular first supporting element in the form of the bottom chord pipe 7a, the recess is formed accordingly in the shape of a segment of a circle. The hybrid connection thus comprises a form-fitting connection and an integrally bonded connection between the first and second supporting elements.

Alternatively, the attachment element 10 can also be form-fittingly fastened to the first supporting element, e.g. by means of a bolt connection extending through the first supporting element and therefore the hybrid connection has two form-fitting connections between the first and second supporting elements.

The attachment element 10 can also be formed by the connecting element 9 itself or can be welded thereto as an additional component.

In the same manner, the first end 8a of each diagonal strut 8 is attached to the associated top chord pipe 6a or optionally the second bottom chord pipe 7a. The connection of the diagonal struts 8 extending between both top chord tubes 6a is also formed in the same manner.

The invention described in this case is not restricted to mobile wharf cranes but instead also includes similarly constructed supporting structures of the types of crane mentioned in the introduction which are a component of the crane girders and in particular crane jibs thereof. In this case, corresponding supporting structures can also be a component of the latticework constructions of masts which have a latticework-like structure and are also defined as a lattice mast.

Corresponding supporting structures are also used as a component of bracing constructions in the sense mentioned in the introduction. Also provided in this case are first supporting elements consisting of a metallic material, in particular a steel material, which are connected to second supporting elements which are produced from fibre composite material and serve as bracing elements. These second supporting elements are likewise elongate and in particular rod-shaped, preferably tubular. In this case, the required hybrid connection can be configured in a similar manner to the one described above.

1. Crane comprising a supporting structure which is a component of a latticework construction of a mast or crane girder, in particular of a jib, or of a bracing construction of the crane, wherein the supporting structure comprises a first supporting element and a second supporting element connected to the first supporting element, wherein the second supporting element is produced from a fibre composite material, in particular CFRP or GFRP, wherein the first supporting element is connected to the second supporting element via a connecting element which has projections that project into the fibre composite material of the second supporting element so that the connecting element is form-fittingly connected to the second supporting element for fastening the first supporting element to the second supporting element.

2. Crane as claimed in claim 1, wherein the second supporting element is rod-shaped.

3. Crane as claimed in claim 1 wherein the connecting element is cylindrical.

4. Crane as claimed in claim 1 wherein the projections are arranged on an outer circumferential surface of the connecting element and project, on an inner surface of the second supporting element into the fibre composite material.

5. Crane as claimed in claim 1 wherein the first supporting element is produced from a metallic material.

6. Crane as claimed in claim 1 wherein the second supporting element is fastened to the first supporting element by means of an attachment element, the attachment element is arranged between the connecting element and the first supporting element and is welded to the first supporting element.

7. Crane as claimed in claim 1 wherein the second supporting element is a diagonal strut of a latticework construction of a mast or crane girder.

8. Crane as claimed in claim 1 wherein the first supporting element is a component of a top chord or bottom chord of the mast or crane girder.

9. Crane as claimed in claim 2 wherein the second supporting element is tubular.

10. Crane as claimed in claim 2 wherein the connecting element is cylindrical.

11. Crane as claimed in claim 2 wherein the projections are arranged on an outer circumferential surface of the connecting element and project, on an inner surface of the second supporting element into the fiber composite material.

12. Crane as claimed in claim 3 wherein the projections are arranged on an outer circumferential surface of the connecting element and project, on an inner surface of the second supporting element into the fiber composite material.

13. Crane as claimed in claim 1 wherein the projections are arranged on an outer circumferential surface of the connecting element and project on an inner surface of the second supporting element at the end thereof and into the fibre composite material.

14. Crane as claimed in claim 1 wherein the projections are arranged on an outer circumferential surface of the connecting element and project, on an inner surface of the second supporting element into the fibre composite material and the outer circumferential surface lies against the inner surface.

15. Crane as claimed in claim 1 wherein the first supporting element is produced from a steel material.

16. Crane as claimed in claim 1 wherein the second supporting element is a diagonal strut of a latticework construction of a jib or a bracing element of a bracing construction of the crane.

17. Crane as claimed in claim 1 wherein the first supporting element is a component of a top chord or bottom chord of the jib.
